(19) United States
(12) Patent Application Publication
(10) Pub. No.: US 2022/0015333 A1
(43) Pub. Date: Jan. 20, 2022

(54) ARTICULATING LEG WRAP

(71) Applicant: GINNY R. FORGY, LEAWOOD, KS (US)

(72) Inventor: GINNY R. FORGY, LEAWOOD, KS (US)

(21) Appl. No.: 16/932,543

(22) Filed: Jul. 17, 2020

(51) Int. Cl. A01K 13/00

(52) U.S. Cl. CPC A01K 13/007

(57) ABSTRACT

The present invention provides an improved articulating leg wrap configured for movement between an unwrapped orientation and a wrapped orientation around a leg, the improved articulating leg wrap comprising an upper section, a lower section extending from a first side to a second side, said first side presenting a releasable fastener for securing said lower section to said upper section, an articulating joint extending between said upper and said lower section, a plurality of upper fasteners extending from said upper section and configured for securing said upper section in the wrapped orientation, a lower section fastener configured for securing said lower section in the wrapped orientation, and a visual display surface presented by said upper section, said lower section, said plurality of upper fasteners and said lower section fastener adapted for receipt of a visual indicia along said visual display surface.

### FIELD OF THE INVENTION

The present application generally relates to protective wraps for animals and more particularly to an improved wrap for animals which provides a padded structure for protecting, resting and healing the leg of a animal such as a horse using an improved fastening mechanism which allows for improved visual customization, providing an improved visual appearance of the leg wrap.

### BACKGROUND OF THE INVENTION

Horses are used around the world for a variety of things. For example, over 3 million horses compete in various shows, races and fairs around the world. In addition, there are a large number of horses which are used for recreational activities. Traditionally, a horse is provided with various shoes to help protect and support the outer edge of the hoof. Theses shoes, however, only protect the foot of the horse. It is well known that horses, especially those engaged in sporting competitions are susceptibility to injury on their legs. As a result, many horse owners keep the legs wrapped up to help protect them from injury or when they are injured, to help them heal. Currently, some owners wrap the rear legs with fetlock boots made of leather or neoprene with mechanical closures. In protecting the front legs, some owners use splint boots or tendon boots to help protect the shins as well as the tendons running along the front legs. However, in wrapping these legs using leather and neoprene, the current mechanical fasteners often fail because they are weak or because over time, they become weaker. In addition, the upper and lower areas of the animals legs require different support structure. Many protective wraps are designed with a single support which does not adequately support both areas.

In addition, in some activities the appearance of the horse is important to the owner, other horses and riders. Grooming and detailing the appearance of the horse can take a great deal of time and in some cases, requires the removal of the protective wraps which are used on the horse to help keep it from being injured or to help it heal from an injury. The ability to customize or enhance the visual appearance of the horse while allowing it to keep its protective wraps in place would be beneficial.

Based in part on the foregoing challenges, there exists a need for an improved protective wrap with improved fasteners which also allows for quick and easy visual changes.

### SUMMARY OF THE INVENTION

The need for the present invention is met, to a great extent, by an improved articulating leg wrap configured for movement between an unwrapped orientation and a wrapped orientation around a leg, said improved articulating leg wrap comprising an upper section, a lower section extending from a first side to a second side, said first side presenting a releasable fastener for securing said lower section to said upper section, an articulating joint extending between said upper and said lower section, a plurality of upper fasteners extending from said upper section and configured for securing said upper section in the wrapped orientation, a lower section fastener configured for securing said lower section in the wrapped orientation and a visual display surface presented by said upper section, said lower section, said plurality of upper fasteners and said lower section fastener adapted for receipt of a visual indicia along said visual display surface.

In one embodiment, the improved articulating leg wrap is light weight, allows for flexibility and is securely positioned along the front and rear legs of the animal. The improved articulated wrap presents and an upper section joined from a lower section each with different support structures. The upper section extends from a first side spaced to a second side, the second side including a plurality of improved fasteners extending from the second side towards the first side. The upper section is joined at a centrally located junction to the lower section. The lower section extends from a lower first side to a lower second side with a fastener extending from the lower second side to the lower first side. The upper section includes an inward facing padded material which extends substantially along the upper section. In addition, the horizontally orientated straps, the upper and lower sections presents an outer surface for receiving removable visual indicia.

The visual indicia is secured to the wrapping along the horizontal straps, the upper and the lower sections for receiving a plurality of ornamental articles, a fashion display accessory fixedly secured to the upper section, the lower section and the horizontal straps of the wrapping, the visual indicia including a body formed of a resilient material secured to an underlying fastening component which is fastened to the at least one of the upper, lower and strap components. The visual indicia generally present an elongated visual component associated with the fashion accessory sized for releasable engagement with, and disengagement from the upper, lower and strap components by application of axially directed force, whereby visual indicia are removably attached to the wrap by cooperative engagement with the visual indicia.

Certain embodiments of the invention are outlined above in order that the detailed description thereof may be better understood, and in order that the present contributes to the art may be better appreciated. There are, of course, additional embodiments of the invention that will be described below and which will form the subject matter of any claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein as well as the abstract are for the purposes of description and should not be regarded as limiting.

As such, those skilled in the relevant art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

Further features of the present invention will become apparent to those skilled in the art to which the present invention relates from reading the following description with reference to the accompanying drawings, in which a better understanding of the present invention is depicted, in which:

FIG. 1 is a rear perspective of an exemplary embodiment of the improved articulated leg wrap in an unwrapped position.

FIG. 2 is a fragmented rear perspective of the improved articulated leg wrap of FIG. 1.

FIG. 3 is a fragmented rear perspective of the improved articulated leg wrap of FIG. 1.

FIG. 4 is front perspective of the improved articulated leg wrap of FIG. 1 in the wrapped position.

FIG. 5 is a side perspective of the improved articulated leg wrap of FIG. 1 in the wrapped position.

FIG. 6 is a rear perspective of the improved articulated leg wrap of FIG. 1 in the wrapped position with an exemplary animal leg.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

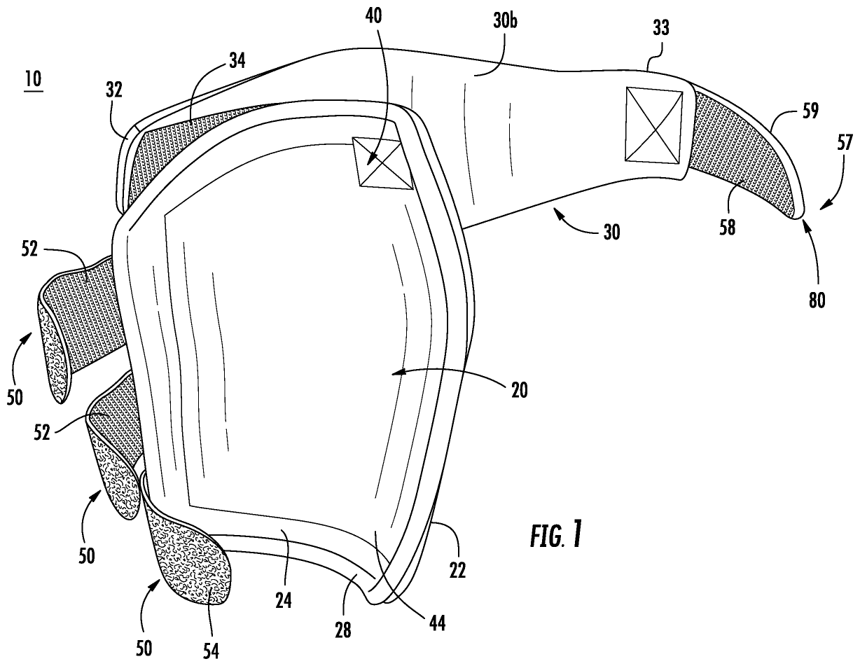

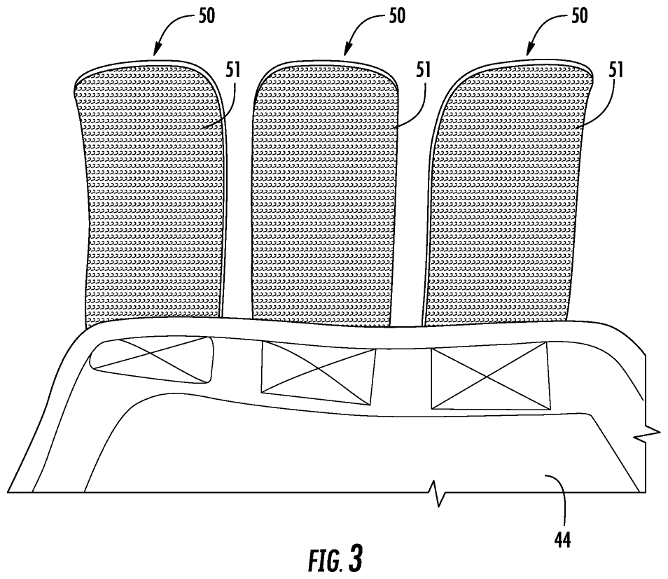

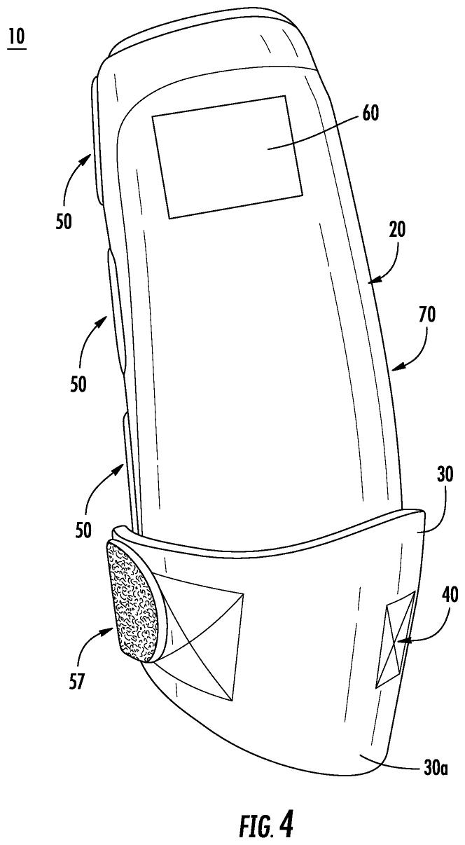

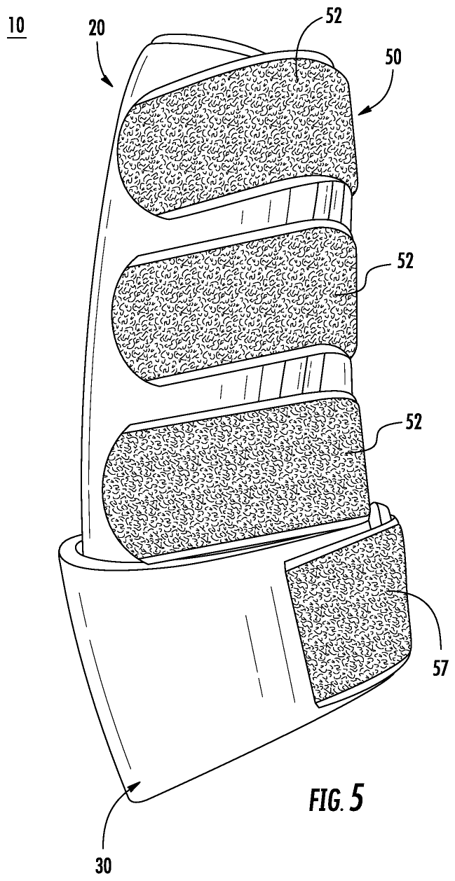

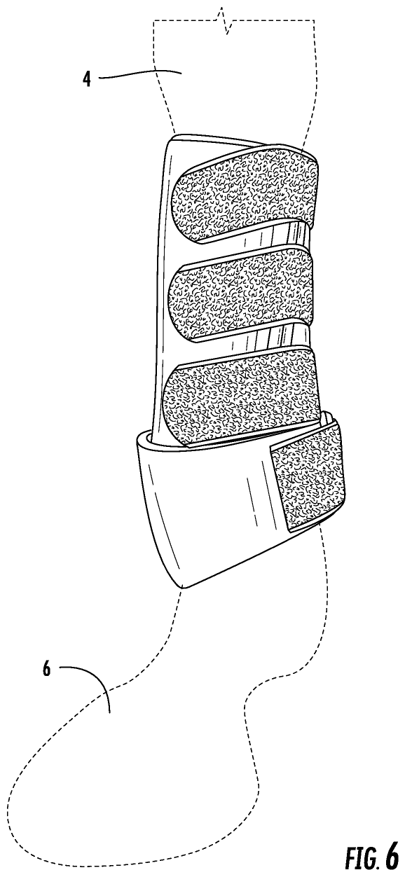

Accordingly, the above problems and difficulties are obviated, at least in part, by the present device which provides an improved articulated leg wrap for an animal 10 including a lower section 30 and an upper section 20 with the lower section 30 layered on top of the upper section 30 and secured at an articulating juncture 40. The improved articulating leg wrap 10 generally extends between an unwrapped position illustrated in FIGS. 1-3 and a wrapped position illustrated in FIGS. 4-6.

As illustrated in FIG. 1, the upper section 20 is generally rectangularly shaped with an outer surface 22, an inner surface 24 and a circumferential edge 28 joining the outer surface 22 to the inner surface 24. One embodiment of the upper section 20, includes a tapered bottom which is narrower than the top. Generally, the outer surface 22 is comprised of a fiberous material such as a napped or piled synthetic or natural material which may be between 30 and 350 GSM. Generally, the inner surface 24 is a thicker, smooth synthetic or natural material which is between 1 and 20 mm thick.

In the embodiment depicted in FIG. 1, a padding 44 is secured to the inner surface 24. Generally, the padding extends inwardly from the inner surface 24. While the improved articulating leg wrap 10 is in the wrapped-position the padding 44 is configured to extend circumferentially along the animals leg 4 by forming compression cylinder which extends radially inward towards the leg 4. The padding 44 applies compression to the leg 4 to help support the muscles, tendons and joints along the leg 4. The compression applied to the leg 4 by the padding 44 provides lateral stability to the leg 4 which may also provide therapeutic benefits by reducing swelling, edema and helping with pain management. In one embodiment, the padding 44 may also be porous for the receiving and applying topical treatments like salves or other ointments to the leg while the improved articulating leg wrap 10 is in the wrapped orientation to further help with leg swelling, edema or associated leg pain.

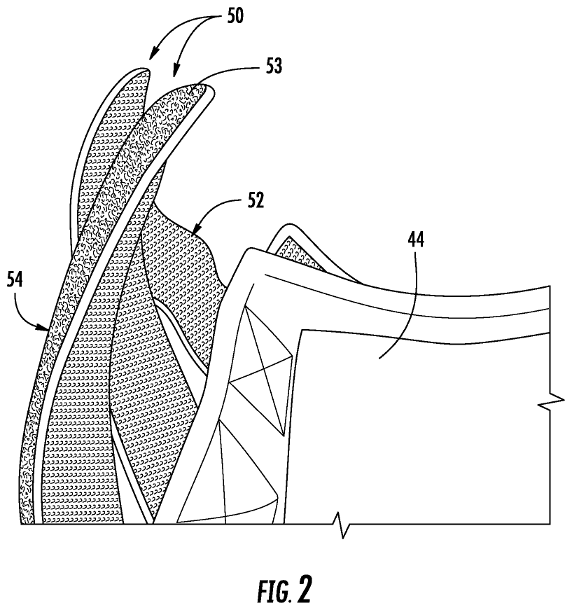

A plurality of upper fasteners 50 are illustrated in FIGS. 1-2. The upper fasteners 50 are elongated fasteners with a plurality of hooks 51 and loops 53 extending along the outer fastener surface 54 and inner fastener surface 52. The upper fasteners 50 include a single dual sided membrane with the plurality of hooks 51 extending directly from the plurality of loops 53. In addition, the upper fasteners 50 illustrated in FIGS. 1-2 utilize a hook and loop type fastener with increased fastening density from the typical hook and loop style fastener with a density of attachments per cm²which ranges between 50 and 75. As illustrated in FIG. 2, the upper fasteners 50 are secured at one end to the outer surface 22, the free end extending outwardly therefrom.

The lower section 20 is illustrated in FIGS. 1, 4-6. The lower section 20 is generally elliptical and extends through the articulating joint 40 from a first side 32 to a second side 33. The portion of the lower section 30 which extends through the articulating joint 40 is generally wider than the first and second sides 32, 33. The lower section 30 includes a lower outer surface 30a and a lower inner surface 30b. The lower inner surface 30b faces the outer surface 22 of the upper section 20 and is generally smooth. The lower outer surface 30a extends outwardly and presents a fibrous surface, forming part of the visual display surface 70.

As illustrated in FIGS. 1 and 4, the articulating joint 40 is a low-profile joint which joins the upper and lower sections 20, 30. The articulating joint 40 is generally flexible and allows movement between an unwrapped orientation depicted in FIGS. 1-3 and a wrapped orientation depicted in FIGS. 4-6. Generally, the articulating joint 40 is centrally located for extension between the upper and lower sections 20, 30. The articulating joint 40 maintains radial spacing of the lower section 30 from the upper section 20 during movement of the lower section 30 about the upper section 20 as they extends between the wrapped and unwrapped orientations. In one embodiment, the articulating joint 40 is comprised of a plurality of threaded members with a membrane fastener extending between the upper and lower sections 20, 30 to receive and support the threaded members during articulation of the lower section 30 about the upper section 20 during movement between the wrapped orientation and the unwrapped orientations.

A releasable fastener 34 is associated with the first side 32 for releasably securing the lower section 30 to the upper section 20 in a radially spaced, overlying orientation. As depicted in FIG. 1, the releasable fastener 34 is positioned along the lower inner surface 30b near the first side 32. The releasable fastener 34 generally has complementary securing structure, like hook and loop fasteners, for releasable engagement with outer surface 22 of the upper section 20.

A lower section fastener 57 is depicted as an elongated flexible member extending from the second side 33. Generally, the lower section fastener 57 includes a releasable fastener surface 58 and an outward fastener surface 59, the releasable fastener surface 58 configured for releasable securing the second side 33 of the improved articulating leg wrap 10 in the wrapped orientation. The releasable fastener surface 58 depicted in FIG. 1 includes a number of hook type structure for releasable receipt to a fibrous or loop type structure. The outward fastener surface 59 generally presents a fibrous surface, forming par of the visual display surface 70.

The embodiment of the improved articulating leg wrap 10, presents the visual display surface 70 which extends circumferentially along the outer surface 22, the outer fastener surface 54, the lower outer surface 30a and the outward fastener surface 59 for receipt of a removeable visual indicia 60. The visual display surface 70 is generally a fibrous material which is configured for releasable receipt of the visual indicia 60. In addition, the visual display surface 70 includes a fabric fastener 64 which extends from the visual indicia 60.

The visual indicia 60 is positioned over the fabric fastener 64 which as depicted may include a hook material compatible for engagement with the visual display surface 70. The fabric fastener 64 is generally planar and configured for extension substantially along the underside of the visual indicia 60. The visual indicia 60 may further include an intermediary substrate 62 which extends between the visual indicia and the fabric fastener 64 and has sufficient structure for receiving the visual indicia 60 and securing it to the fabric fattener 64. In one exemplary embodiment, the intermediary substrate 62 is configured for releasable engagement with the fabric fastener 64. The fabric fastener 64 may include a hook material or both a hook and loop material configured for engagement with the intermediary substrate 62. The visual indicia 60 may include an outer perimeter 61 that is free from the intermediary substrate 62. The fabric fattener 64 generally adheres to the visual display surface 70 associated with the upper fasteners 50, the upper and lower sections 20, 30 of the improved articulating leg wrap 10.

Once the visual indicia 60 is properly positioned along the visual display surface 70, the visual indicia 60 presents a visual appearance which changes the look and style of the improved articulating leg wrap 10, as desired. The visual indicia 60 is easily detachable and can be move to other locations along the visual display surface 70. The intermediary substrate 62, being flexible can be manipulated for removal and replacement as desired along the visual display surface 70. The use of hook and loop fasteners promotes the ready attachment and detachment of the visual indicia 60 from the visual display surface 70 from each of the upper and lower sections 20, 30.

It is to be understood that while certain forms of the present invention have been illustrated and described herein, it is not to be limited to the specific forms or arrangement of parts describer herein. Other arrangements or embodiments, changes and modifications not precisely set forth, which can be practiced under the teachings of the present invention are to be understood as being included within the scope of this invention as set forth in the claims below.

What is claimed and desired to be secured by Letters Patent:

1. An improved articulating leg wrap configured for movement between an unwrapped orientation and a wrapped orientation around a leg, said improved articulating leg wrap comprising:
an upper section;
a lower section extending from a first side to a second side, said first side presenting a releasable fastener for securing said lower section to said upper section;
an articulating joint extending between said upper and said lower section;
a plurality of upper fasteners extending from said upper section and configured for securing said upper section in the wrapped orientation;
a lower section fastener configured for securing said lower section in the wrapped orientation; and
a visual display surface presented by said upper section, said lower section, said plurality of upper fasteners and said lower section fastener adapted for receipt of a visual indicia along said visual display surface.

2. An improved articulating leg wrap of claim 1 wherein said articulating joint radially secures said lower section to said upper section as said lower section rotates about said upper section during movement between said wrapped orientation and said unwrapped orientation.
